(19) United States
(12) Patent Application Publication
(10) Pub. No.: US 2022/0343161 A1
(43) Pub. Date: Oct. 27, 2022

(54) DEVICE AND METHOD FOR EMBEDDED DEEP REINFORCEMENT LEARNING IN WIRELESS INTERNET OF THINGS DEVICES

(71) Applicant: Northeastern University, Boston (US)

(72) Inventors: Francesco Restuccia, Boston, MA (US); Tommaso Melodia, Newton, MA (US)

(21) Appl. No.: 17/753,670

(22) PCT Filed: Sep. 18, 2020
(86) PCT No.: PCT/US2020/051597

§ 371 Date: Mar. 10, 2022

Related U.S. Application Data
(60) Provisional application No. 62/903,701, filed on Sep. 20, 2019.

(51) Int. Cl. G06N 3/08; G06N 3/063; G06N 3/04; H04W 4/70

(52) U.S. Cl. CPC G06N 3/08; G06N 3/063; G06N 3/0454; H04W 4/70; G16Y 40/10

(57) ABSTRACT

A networking device, such as an Internet of Things (IoT) device, implements an operative neural network (ONN) to optimize an internal wireless transceiver based on detected radio frequency (RF) spectrum conditions. The wireless transceiver detects the RF spectrum conditions local to the networking device and generates a representation of the RF spectrum conditions. The ONN determines transceiver parameters based on the RF spectrum conditions. A controller causes the representation of the RF spectrum conditions to be transmitted to a network node. Independent of the networking device, a training neural network (TNN) is trained based on the representation of the RF spectrum conditions, and neural network (NN) parameters are generated via the training a function of the representation of the RF spectrum conditions. The controller then reconfigures the ONN based on the NN parameters.

### RELATED APPLICATION

This application claims the benefit of U.S. Provisional Application No. 62/903,701, filed on Sep. 20, 2019. The entire teachings of the above application are incorporated herein by reference.

### GOVERNMENT SUPPORT

This invention was made with government support under Grant Number N00014-18-9-0001 from Office of Naval Research. The government has certain rights in the invention.

### BACKGROUND

The scale of the Internet of Things (IoT), expected to reach 18 billion devices by 2022, will impose a never-before-seen burden on today's wireless infrastructure. As a further challenge, existing IoT wireless protocols such as WiFi and Bluetooth are deeply rooted in inflexible, cradle-to-grave designs, and thus are unable to address the demands of the next-generation IoT. In particular, such technologies may be unable to self-optimize and adapt to unpredictable or even adversarial spectrum conditions. If unaddressed, these challenges may lead to severe delays in IoT's global development.

Thus, it has now become crucial to re-engineer IoT devices, protocols and architectures to dynamically self-adapt to different spectrum circumstances. Recent advances in deep reinforcement learning (DRL) have stirred up the wireless research community. DRL has shown to provide near-human capabilities in a multitude of complex tasks, from playing video games to beating world-class Go champions. The wireless research community is now working to apply DRL to address a variety of critical issues, such as handover and power management in cellular networks, dynamic spectrum access, resource allocation/slicing/caching, video streaming, and modulation/coding scheme selection.

### SUMMARY

Advances in deep reinforcement learning (DRL) may be leveraged to empower wireless devices with the much-needed ability to “sense” current spectrum and network conditions and “react” in real time by either exploiting known optimal actions or exploring new actions. Yet, previous approaches have not explored whether real-time DRL can be at all applied in the resource-challenged embedded IoT domain, as well as designing IoT-tailored DRL systems and architectures. Example embodiments provide a general-purpose, hybrid software/hardware DRL framework specifically tailored for wireless devices such as embedded IoT wireless devices. Such embodiments can provide abstractions, circuits, software structures and drivers to support the training and real-time execution of DRL algorithms on the device's hardware. Moreover, example embodiments can provide a novel supervised DRL model selection and bootstrap (S-DMSB) process that leverages transfer learning and high-level synthesis (HLS) circuit design to provide a neural network architecture that satisfies hardware and application throughput constraints and speeds up the DRL algorithm convergence. Example embodiments can be implemented for real-time DRL-based algorithms on a real-world wireless platform with multiple channel conditions, and can support increases (e.g., 16×) data rate and consume less energy (e.g., 14×) than a software-based implementation. Such embodiments may also greatly improve the DRL convergence time (e.g., by 6×) and increase the obtained reward (e.g., by 45%) if prior channel knowledge is available.

Example embodiments include a networking device comprising a wireless transceiver, a hardware-implemented operative neural network (ONN), and a controller. The wireless transceiver may be configured to detect radio frequency (RF) spectrum conditions local to the networking device and generate a representation of the RF spectrum conditions. The ONN may be configured to determine transceiver parameters based on the representation of the RF spectrum conditions. The controller may be configured to 1) cause the representation of the RF spectrum conditions to be transmitted to a network node, and 2) reconfigure the ONN based on neural network (NN) parameters generated by a training neural network (TNN) remote from the networked device, the NN parameters being a function of the representation of the RF spectrum conditions.

The representation of the RF spectrum conditions may include I/Q samples. The controller may be further configured to generate an ONN input state based on the representation of the RF spectrum conditions, and the ONN may be further configured to process the ONN input state to determine the transceiver parameters. The wireless transceiver may be further configured to reconfigure at least one internal transmission or reception protocol based on the transceiver parameters. Following the reconfiguration of the ONN based on the NN parameters, the ONN may be further configured to determine subsequent transceiver parameters based on a subsequent representation of the RF spectrum conditions generated by the wireless transceiver.

The networking device may be a battery-powered Internet of things (IoT) device. The ONN may be further configured to determine the transceiver parameters within 1 millisecond of the wireless transceiver generating a representation of the RF spectrum conditions. The ONN may be configured in a first processing pipeline, and a second processing pipeline may be configured to 1) buffer the representation of the RF spectrum conditions concurrently with the ONN determining the transceiver parameters, and 2) provide the representation of the RF spectrum conditions to the wireless transceiver in synchronization with the transceiver parameters.

Further embodiments include a method of configuring a wireless transceiver. Radio frequency (RF) spectrum conditions local to the networking device may be detected, and a representation of the RF spectrum conditions may be generated. At a hardware-implemented operative neural network (ONN), transceiver parameters may be determined based on the representation of the RF spectrum conditions. At least one internal transmission or reception protocol of the wireless transceiver may be reconfigured based on the transceiver parameters. The representation of the RF spectrum conditions may be transmitted to a network node remote from the wireless transceiver. The ONN may then be reconfigured based on neural network (NN) parameters generated by a training neural network (TNN), the NN parameters being a function of the representation of the RF spectrum conditions.

The TNN may be trained based on the representation of the RF spectrum conditions, and the NN parameters may be generated, via the TNN, as a result of the training. The TNN may be trained in a manner that is asynchronous to operation of the ONN. The TNN may be trained based on at least one state/action/reward tuple generated from the representation of the RF spectrum. A TNN experience buffer may be updated to include the at least one state/action/reward tuple. The NN parameters may be transmitted from the network node to the wireless transceiver.

Further, a software-defined NN may be trained to classify among different state conditions of a RF spectrum. The state of the software-defined NN may be translated to ONN parameters. The ONN parameters may be compared against at least one of a size constraint and a latency constraint. The ONN may then be caused to be configured based on the ONN parameters.

Further embodiments include a connected things device. A connected things application may be configured to process an input stream of input data representing real-world sensed information and to produce an output stream of output stream data that is stored in a buffer and released from the buffer with the timing that is a function of real-world timing. An ONN may be configured to process the input stream of input data and produce a deep reinforcement learning (DRL) action at a rate aligned with the output of the buffer. An adapter may be configured to accept the output stream of data from the buffer and the DRL action and to produce an output that is a function of the DRL action.

The ONN may have a processing latency that matches the latency of the connected things application and buffering such that the output stream of data and the DRL action are aligned with each other. The connected things application may be coupled to real-world sensors that are configured to collect data at a rate sufficient to enable the I/O the connected things device to operate in real-time. The ONN may be implemented in a programmable logic device and may be trained to reach a convergence based on continuous operation in a parallel flow path with the iota with the connected things application. The ONN may be configured to receive a DRL state input and TN and parameters input and configured to output a DRL action that is combined with the connected things application in a manner that real-world timing aligns corresponding states to be combined in a meaningful manner that enables the connected things device to perform actions in real-time.

The ONN may be configured through a supervised training system that selects a neural network model as a function of latency and hardware size constraints. The ONN may be implemented in a programmable logic device and the connected things application is implemented in a processing system. The connecting things application may be coupled to the connected things device via a wireless communications path.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a system in an example embodiment.

FIG. 2 is a block diagram of a system in a further embodiment.

FIG. 3 is a block diagram of a wireless device in one embodiment.

FIG. 4 is a flow diagram of a process of initial training of an operative neural network (ONN) in one embodiment.

FIG. 5 is a flow diagram of a process of configuring a wireless transceiver in one embodiment.

FIG. 6 is a table for a randomized cross entropy process in one embodiment.

FIG. 7 is a set of charts depicting latency performance of a networking device in an example embodiment.

FIG. 8 is a chart depicting power consumption of a networking device in an example embodiment.

FIG. 9 is a chart depicting accuracy of DNN models in one embodiment.

FIG. 10 is a plot depicting example training data comprising channel I/Q taps.

FIG. 11 is a series of graphs depicting the reward, loss function and average action per episode in one embodiment.

FIG. 12 is a graph depicting average reward and action obtained by processes in one embodiment.

### DETAILED DESCRIPTION

A description of example embodiments follows.

Deep reinforcement learning (DRL) algorithms can solve partially-observable Markov decision process (POMDP)-based problems without any prior knowledge of the system's dynamics. Therefore, DRL may be an ideal choice to design wireless protocols that (i) optimally choose among a set of known network actions (e.g., modulation, coding, medium access, routing, and transport parameters) according to the current wireless environment and optimization objective; and (ii) adapt in real time the IoT platform's software and hardware structure.

Despite the ever-increasing interest in DRL from the wireless research community, existing algorithms have only been evaluated through simulations or theoretical analysis, which has substantially left the investigation of several key system-level issues uncharted territory. One cause is that the resource-constrained nature of IoT devices brings forth a number of core research challenges, both from the hardware and learning standpoints, that are practically absent in traditional DRL domains.

Two aspects of DRL are a training phase, wherein the agent learns the best action to be executed given a state, and an execution phase, where the agent selects the best action according to the current state through a deep neural network (DNN) trained during the training phase. Traditionally, DRL training and execution phases are implemented with graphics processing unit (GPU)-based software and run together in an asynchronous manner, meaning without any latency constraints. In contrast, in the embedded wireless domain, the DRL execution phase must run in a synchronous manner, meaning with low, fixed latency and with low energy consumption, features that are better suited to a hardware implementation. This is because (i) the wireless channel may change in a matter of a few milliseconds and is subject to severe noise and interference, and (ii) RF components operate according to strict timing constraints. For example, if the channel's coherence time is approximately 20 ms, the DNN must run with latency much less than 20 ms to (i) run the DNN several times to select the best action despite of noise/interference; and (ii) reconfigure the hardware/software wireless protocol stack to implement the chosen action, all without disrupting the flow of I/Q samples from application to RF interface. Existing approaches do not account for the critical aspect of real-time DRL execution in the wireless domain.

Further, the strict latency and computational constraints necessarily imposed by the embedded IoT wireless domain should not come to the detriment of the DRL performance. Indeed, typical DRL algorithms are trained in powerful machines located in a cloud computing network, which can afford computationally-heavy DRL algorithms and DNNs with hundreds of thousands of parameters. Such computation is not practical in the IoT domain, where devices are battery-powered, their CPUs run at few hundreds of megahertz, and possess a handful of megabytes of memory at best. Therefore, a core challenge is how to design a DNN “small” enough to provide low latency and energy consumption, yet also “big” enough to provide a good approximation of the state-action function. This is particularly crucial in the wireless domain, since the RF spectrum is a very complex phenomenon that can only be estimated and/or approximated on-the-fly. This implies that the stationarity and uniformity assumptions usually made in traditional learning domains may not necessarily apply in the wireless domain.

Example embodiments address the challenges described above to provide improved communications for wireless devices. Example embodiments provide a general-purpose, hybrid software/hardware DRL framework specifically tailored for wireless devices such as embedded IoT wireless devices. Such embodiments can provide abstractions, circuits, software structures and drivers to support the training and real-time execution of DRL algorithms on the device's hardware. Moreover, example embodiments can provide a novel supervised DRL model selection and bootstrap (S-DMSB) process that leverages transfer learning and high-level synthesis (HLS) circuit design to provide a neural network architecture that satisfies hardware and application throughput constraints and speeds up the DRL algorithm convergence. Example embodiments can be implemented for real-time DRL-based algorithms on a real-world wireless platform with multiple channel conditions, and can support increases (e.g., 16×) data rate and consume less energy (e.g., 14×) than a software-based implementation. Such embodiments may also greatly improve the DRL convergence time (e.g., by 6×) and increase the obtained reward (e.g., by 45%) if prior channel knowledge is available.

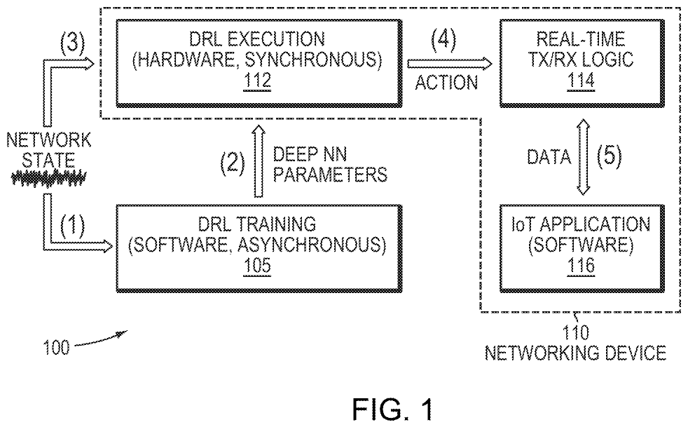

FIG. 1 provides an overview of a system 100 in an example embodiment. The system 100 includes a networking device 110 comprising a DRL execution unit 112 (e.g., a hardware-based DNN), a transceiver logic unit 114, and an IoT application 116. A DRL training unit 105 may be communicatively coupled to the networking device 110. Operations for configuring communications of the networking device 110 may be divided into two tasks: (i) an asynchronous, software-based DRL training process (1), wherein the training unit 105 learns to select the best policy according to a given network state (e.g., radio frequency (RF) spectrum conditions local to the networking device); and (ii) a synchronous, hardware-based DRL execution process, wherein the results of the training (e.g., deep neural network (DNN) parameters) are periodically sent (2) to the networking device 110 to update the DRL execution unit 112 to enforce the execution of the policy. The networking device 110, in turn, may operate the DRL execution unit 112 to select an action based on the current network state (3) and then enforce the action by updating a configuration of the transceiver logic unit 114 (4). The IoT application 116 may then proceed to operate with the transceiver logic unit 114 to transmit/receive its data according to the new transceiver configuration determined by the DRL execution unit 112 (5).

When implemented in an IoT or other networking platform, the system 100 differs from previous approaches in several ways. For example, the system 100 physically separates two traditionally interconnected steps (DRL training and execution) by (a) configuring a DNN at a hardware portion of the platform to guarantee real-time constraints; and (b) interconnecting the DNN both to the DRL training phase and to the RF components of the platform to enforce the real-time application of the action selected by the hardware-based DNN. This configuration enable the system 100 to (i) guarantee real-time and low-power requirements and (ii) make the system 100 general-purpose and applicable to a multitude of software-based DRL training algorithms.

The system 100 can be implemented as an IoT-tailored framework providing real-time DRL execution coupled with tight integration with DRL training and RF circuitry. For example, embodiments of the system 100 may be implemented in a system-on-chip (SoC) architecture integrating RF circuits, DNN circuits, low-level Linux drivers and low-latency network primitives to support the real-time training and execution of DRL algorithms on IoT devices; and (ii) propose a new Supervised DRL Model Selection and Bootstrap (S-DMSB) technique that combines concepts from transfer learning and high- level synthesis (HLS) circuit design to select a deep neural network architecture that concurrently (a) satisfies hardware and application throughput constraints and (b) improves the DRL algorithm convergence.

Reinforcement learning (RL) can be broadly defined as a class of algorithms providing an optimal control policy for a Markov decision process (MDP). There are four elements that together uniquely identify an MDP: (i) an action space A, (ii) a state space S, (iii) an immediate reward function r(s, a), and (iv) a transition function p(s, s′, a), with s , s′□S and a□A core challenge in MDPs is to find an optimal policy π*(s, a), such that the discounted reward is maximized:

R=Σₜ₌₀^{∞}γ^{t}r(sₜ, aₜ), sₜ∈S and aₜ∈A (1)

wherein

0≤γ≤1

is a discount factor and actions are selected from a policy π*.

Different from dynamic programming (DP) strategies, RL can provide an optimal MDP policy also in cases when the transition and reward functions are unknown to the learning agent. Thanks to its simplicity and effectiveness, Q-Learning is one of the most widely used RL algorithm today. Q-Learning is named after its Q(s, a) function, which iteratively estimates the “value” of a state-action combination as follows. First, Q is initialized to a possibly arbitrary fixed value. Then, at each time t the agent selects an action aₜ, observes a reward rₜ, enters a new state sₜ₊₁, and Q is updated. A core aspect of Q-Learning is a value iteration update rule:

$$Q ( {s}_{t} , {a}_{t} ) = ( 1 - α ) \cdot {\underbrace{Q ( {s}_{t} , {a}_{t} )}}_{old value} + {\underbrace{α}}_{learning rate} \cdot {\overbrace{( {\underbrace{{r}_{t}}}_{reward} + {\underbrace{γ}}_{discount factor} \cdot {\underbrace{{max}_{a} Q ( {s}_{t + 1} , a )}}_{estimate of optimal future value} )}}^{learned value} \qquad ( 2 )$$

wherein rt is the reward received when moving from the state St to the state Sₜ₊₁, and 0<a≤1 is the learning rate. An “episode” of the algorithm ends either when state Sₜ₊₁ is a “terminal state” or after a certain number of iterations.

One challenge in traditional RL is the “state-space explosion” problem, meaning that explicitly representing the Q-values in real-world problems is prohibitive. For example, a vector of 64 complex elements may be used to represent the channel state in a WiFi transmission (i.e., number of WiFi subcarriers). Therefore, all possible vectors S□R¹²⁸ may need to be stored in memory, which is not feasible, particularly in the limited memory available in networking devices such as embedded IoT devices.

Deep reinforcement learning (DRL) addresses the state-space explosion issue by using a deep neural network (DNN), also called Q-Network, to “lump” similar states together by using a non-explicit, non-linear representation of the Q-values, i.e., a deep Q-network (DQN). This way, the process may (i) use Equation (2) to compute the Q-values, and then (ii) stochastic gradient descent (SGD) to make the DQN approximate the Q-function. Therefore, DRL may have reduced precision in state-action representation in exchange for a reduced storage requirement.

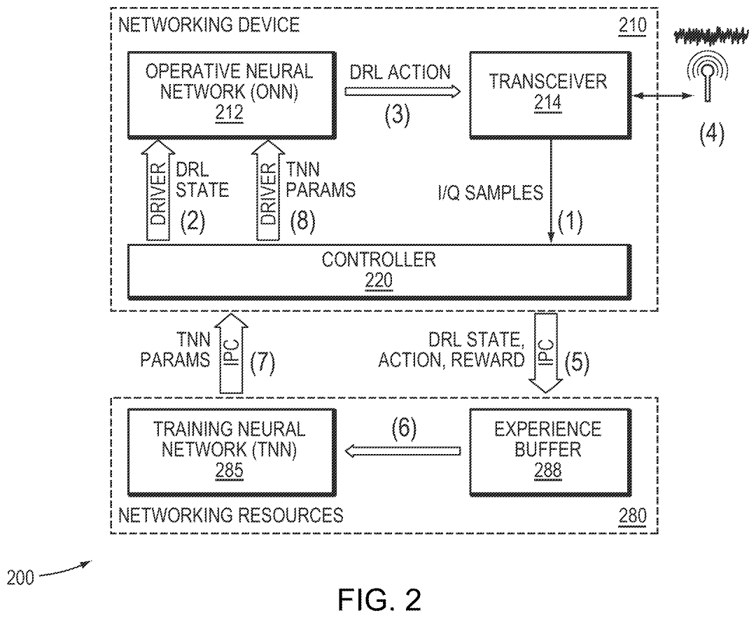

FIG. 2 illustrates a system 200 in a further embodiment, which may incorporate one or more features of the system 100 described above. The system 200 includes a networking device 210, such as an IoT device, which may implement the features of the networking device 110 described above. In particular, the networking device 210 may include an operative neural network (ONN) 212 providing a DRL execution process in hardware (e.g., a field programmable gate array (FPGA)), a transceiver 214 including RF transmitter and receiver circuitry and transceiver protocol stacks, and a controller 220. Example embodiments may be viewed as a self-contained software-defined radio (SDR) platform where the platform's hardware and software protocol stack is continuously and seamlessly reconfigured based on the inference of a DRL algorithm. Due to the generalization and extrapolation abilities of neural networks, it may be infeasible to use a single deep neural network (DNN) to both retrieve and learn the optimal Q-values. Such an approach can lead to a slow or even unstable learning process. Moreover, Q-values tend to be overestimated due to the max operator.

For this reason, example embodiments such as the system 200 may implement network resources 280 remote from the networking device 210, including a training neural network (TNN) 285 configured to provide neural network parameters to the ONN 212. The ONN 212 may updated with the NN parameters from the TNN 285 once every C DRL iterations to prevent instabilities. In contrast to the usage of two DNNs in the software domain, achieving the same architecture in the embedded IoT domain presents various challenges. Critically, this is because the TNN training may be performed over the course of minutes (or hours, in some cases), yet as described below, the ONN must work in the scale of microseconds. Therefore, example embodiments provide a hybrid synchronous/asynchronous architecture able to handle the different time scales. According to recent advances in DRL, an experience buffer 288 may be leveraged to store <state, action, reward> tuples for N time steps. The updates to the TNN are then made on a subset of tuples (referred to as a mini-batch) selected randomly within the replay memory. This technique allows for updates that cover a wide range of the state-action space.

The system 200 may operate as follows. First, at the transceiver 214, the wireless protocol stack, which includes both RF components and physical-layer operations, receives I/Q samples from the RF interface, which are then fed to the controller 220 (1). The controller 220 may generate a DRL state out of the I/Q samples, according to the application under consideration. The DRL state is then sent by the controller 220 to the ONN 212. The ONN 212 may provide, with fixed latency, a DRL action (3), which is then used to reconfigure in real-time the wireless protocol stack of the transceiver 214 (4). This action can update the physical layer (e.g., “change modulation to BPSK”) and/or the MAC layer and above (e.g., “increase packet size to 1024 symbols, use a different CSMA parameters,” etc.). Operations (2)-(4) may be continually performed in a loop fashion, which reuses the previous state if a newer one is not available; this is done to avoid disrupting the I/Q flow to the RF interface.

Once the DRL state has been constructed, it is also sent by the controller 220 to the network resources 280 (also referred to as a “training module”) (5), which may be located in another host outside of the platform (on the edge or in a cloud computing resource). Thus, sockets may be used to asynchronously communicate to/from the platform from/to the training module. The training module may (i) receive the <state, action, reward> tuples corresponding to the previous step of the DRL algorithm; (ii) store the tuples in the experience buffer; and (iii) utilize the tuples in the experience buffer to train the TNN 285 according to the specific DRL algorithm being used (e.g., cross-entropy, deep Q-learning, and so on). The resulting NN parameters are then transmitted to the networking device 210 after each epoch of training (7). Lastly, the controller 220 aplies the NN parameters to update the parameters of the ONN 212 (8).

The networking device 210 may be implemented in a system-on-chip (SoC) architecture, as SoCs (i) integrate CPU, RAM, FPGA, and 1/0 circuits all on a single substrate; and (ii) are low-power and highly reconfigurable, as the FPGA can be reprogrammed according to the desired design.

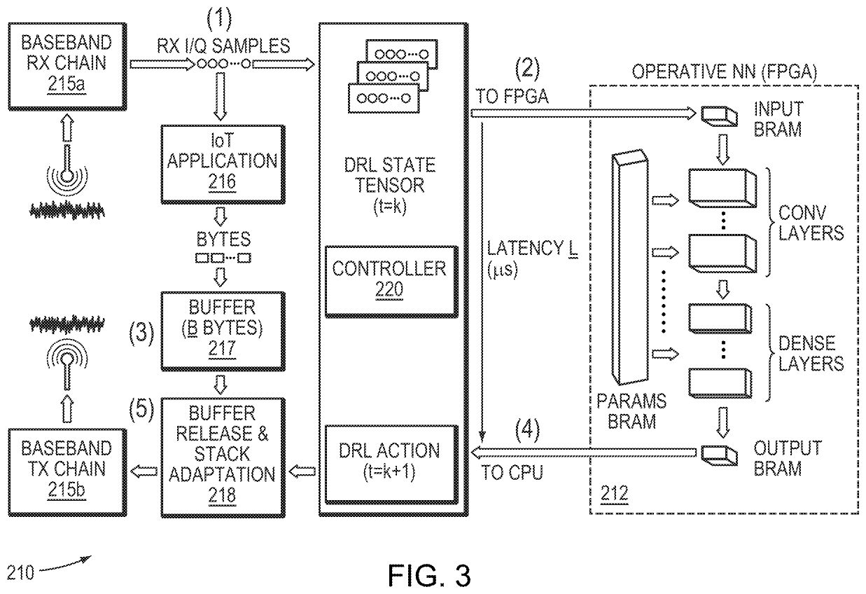

FIG. 3 illustrates the networking device 210 in further detail. Here, the transceiver 214 is shown to include a baseband receive (RX) chain 215a and a baseband transmit (TX) chain 215b. During normal operation, once the I/Q samples have been received and processed by the RX chain 215a (1), and the controller 220 has created the input to the ONN 212 (e.g., the DRL state tensor) as described in further detail below, the input is thus sent to the ONN through a driver (2), which will provide the DRL action after a latency of L seconds (4). At the same time, the IoT application 216 (e.g. a local application utilizing the communications of the networking device 210) generates data bytes for transmission, which are temporarily stored in a buffer 217 of size B bytes (3), as the transceiver 214 is to be reconfigured according to the selected DRL action. Consider that the RF interface is receiving samples at T million samples/sec. Typically, a digital-to-analog converter takes as input I/Q samples that are 4 bytes long in total. Therefore, 4 T MB worth of data must be processed each second to achieve the necessary throughput. Because spectrum data is significantly time-varying, the ONN may be required to run S times each second to retrieve the DRL action on fresh spectrum data. Furthermore, the memory of the platform may be limited. For the sake of generality, the memory of the platform may be considered to allow for maximum of B bytes of data to be buffered. Once the controller 220 provides the DRL action to a buffer release and stack adaptation block 218, the block 218 may update any aspects of the baseband TX chain 215b (and, optionally, the baseband RX chain 215a) as specified by the DRL action, reconfiguring the network protocol stack based on the DRL action selected by the ONN 210. The block 218 may then retrieve the data bytes from the buffer 217, modulates it according to the current network protocol stack, and enable the transceiver 214 to transmit the data bytes across the wireless network.

To summarize, in 1/s seconds, the networking device 210 (i) inserts 4·T/s bytes into a buffer (either in the DRAM or in the FPGA); (ii) send the DRL state tensor to the input BRAM of the ONN through driver; (iii) wait for the ONN to complete its execution after L seconds; (iv) read the DRL action from the output BRAM, (v) reconfigure the protocol stack and release the buffer. By experimental evaluation, (i), (ii), and (v) may be negligible with respect to L, therefore, those delays can be approximated to zero for simplicity. Therefore, to respect the constraints, the following must hold:

$$\{ \begin{matrix}S \cdot L \leq 1 ( time constraint ) \\ \frac{4 \cdot T}{S} \leq B ( memory constraint )\end{matrix} \qquad ( 3 )$$

An example of the magnitude of the above constraints in real-world systems, consider T=20 MS/S (e.g., WiFi transmission) and a goal to sample the spectrum every millisecond S=1000. To sustain these requirements, the ONN's latency L must be less than 1 millisecond, and the buffer B must be greater than 80 KB. The sampling rate T and the buffer size B are hard constraints imposed by the platform hardware/RF circuitry, and can be hardly relaxed in real-world applications. Thus, at a system design level, L and S can be leveraged to meet performance requirements. Moreover, increasing S can help meet the second constraint (memory) but may fail the first constraints (time). On the other hand, decreasing S could lead to poor system/learning performance as spectrum data could be stale when the ONN is run. In other words, an objective is to decrease the latency L as much as possible, which in turn will (i) help us increase S (learning reliability) and thus (ii) help meet the memory constraint.

### TNN and ONN Configuration

As described above, the ONN may be located in the FPGA portion of the platform while the TNN may resides in the cloud/edge. This approach allows for real-time (i.e., known a priori and fixed) latency DRL action selection yet scalable DRL training. A goal of the ONN is to approximate the state-action function of the DRL algorithm being trained at the TNN. On the other hand, differently from the computer vision domain, the neural networks involved in deep spectrum learn- ing should be lower complexity and learn directly from I/Q data. To address these challenges, the TNN/ONN can be implemented with a one-dimensional convolutional neural network (in short, Conv1D). Conv1D may be advantageous over two-dimensional convolutional networks because they are significantly less resource- and computation-intensive than Conv2D networks, and because they work well for identifying shorter patterns where the location of the feature within the segment is not of high relevance. Similarly to Conv2D, a Conv1D layer has a set of N filters Fn□R^{D×W}, 1≤n≤N, where W and D are the width of the filter and the depth of the layer, respectively. By defining as S the length of the input, each filter generates a mapping Oⁿ□R^{S-W+1} from an input I□R^{D×S} as follows:

$${O}_{j}^{n} = {\sum }_{ℓ = 0}^{S - W} {F}_{j - ℓ}^{n} \cdot {I}_{n , ℓ} \qquad ( 4 )$$

The controller 220 may then create an input to the first Conv1D layer of the ONN from the I/Q samples received from the RF interface. Consider a complex-valued I/Q sequence s[k], with k≥0. The w-th element of the d-th depth of the input, defined as I_{w,d}, is constructed as:

I_{d,w}=Re{s[d·δ+w·(σ−1)]}

I_{d,w+1}=Im{s[d·δw·(σ−1)]]}

where 0≤d∈D, 0≤w<W (5)

where σ and δ are introduced as intra- and inter-dimensional stride, respectively. Therefore, (i) the real and imaginary part of an I/Q sample will be placed consecutively in each depth; (ii) one I/Q sample is taken every σ sample; and (iii) each depth is started once every δ I/Q samples. The stride parameters are application-dependent and are related to the learning versus resource tradeoff tolerable by the system 200.

### Supervised DRL Model Selection and Bootstrap (S-DMSB)

A challenge for the embedded IoT domain is selecting the “right” architecture for the TNN and ONN. As described above, the ONN should be “small” enough to satisfy hard constraints on latency. At the same time, the ONN should also possess the necessary depth to approximate well the current network state. To allow DRL convergence, the TNN and ONN architecture should be “large enough” to distinguish between different spectrum states. One challenge here is to verify constraints that are different in nature—classification accuracy (a software constraint), and latency/space constraints (a hardware constraint). Therefore, example embodiments provide for (i) evaluating those constraints and (ii) automatically transitioning from a software-based NN model to a specification for the ONN.

In addition, DRL's weakest point is its slow convergence time. Canonical approaches start from a “clean-slate” neural network (i.e., random weights) and explore the state space with the assumption that the algorithm will converge. Previous approaches have attempted to solve this problem through a variety of approaches, for example, exploring Q-values in parallel. However, these solutions are not applicable to the IoT domain, where resources are limited and the wireless channel changes continuously. For in the wireless domain, in contrast, example embodiments provide a bootstrapping procedure wherein the TNN and ONN start from a “good” parameter set that will help speed up the convergence of the overarching DRL algorithm.

In an example embodiment, an approach referred to as Supervised DRL Model Selection and Bootstrap (S-DMSB) may be implemented to address the above issues at once through transfer learning. Transfer learning allows the knowledge developed for a classification task to be “transferred” and used as the starting point for a second learning task to speed up the learning process. Consider two people who are learning to play the guitar. One person has never played music, while the other person has extensive music background through playing the violin. It is likely that the person with an extensive music knowledge will be able to learn the piano faster and more effectively, simply by transferring previously learned music knowledge to the task of learning the guitar.

Similarly, in the wireless domain, a model can be trained to recognize different spectrum states, and let the DRL algorithm figure out which ones yield the greater reward. This configuration will at once help (i) select the right DNN architecture for the TNN/ONN to ensure convergence and (ii) speed up the DRL learning process when the system 200 is actually deployed.

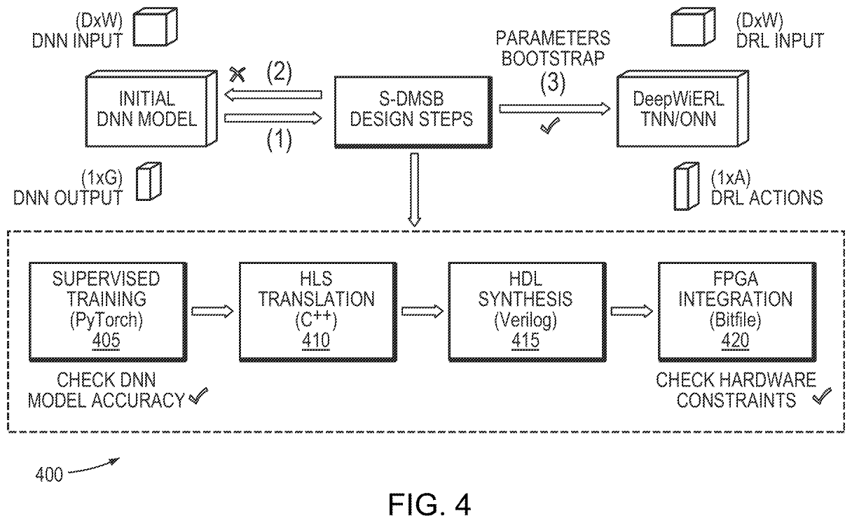

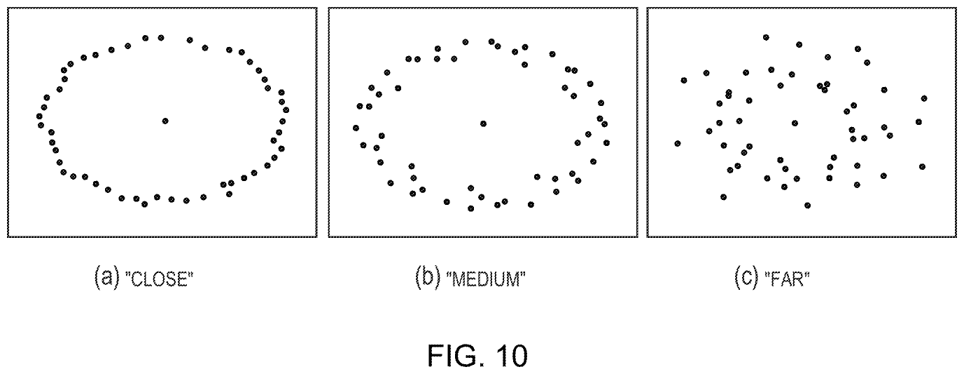

FIG. 4 illustrates a process 400 according to an example S-DMSB technique, which is based on high-level synthesis (HLS). HLS translates a software-defined neural network to an FPGA-compliant circuit, by creating Verilog/VHDL code from code written in C++. The process 400 may begin by training a DNN to classify among G spectrum states (e.g., different SNR levels), such as low, medium, and high SNR, as shown in FIG. 10 (1). Once high accuracy (e.g., 95%) is reached through hyper-parameter exploration, the model is translated with a customized HLS library that generates an HDL description of the DNN in Verilog language (410, 415). Finally, the HDL is integrated with the other circuits in the FPGA and the DNN delay is checked againstthe requirements (420). In other words, if the model does not satisfy the latency constraint or the model occupies too much space in hardware, the model's number of parameters are decreased until the constraints are satisfied (2). Once the latency/accuracy trade-off has been reached, the parameters are transferred to the TNN/ONN networks and used as a starting point (“bootstrap”) for the DRL algorithm (3).

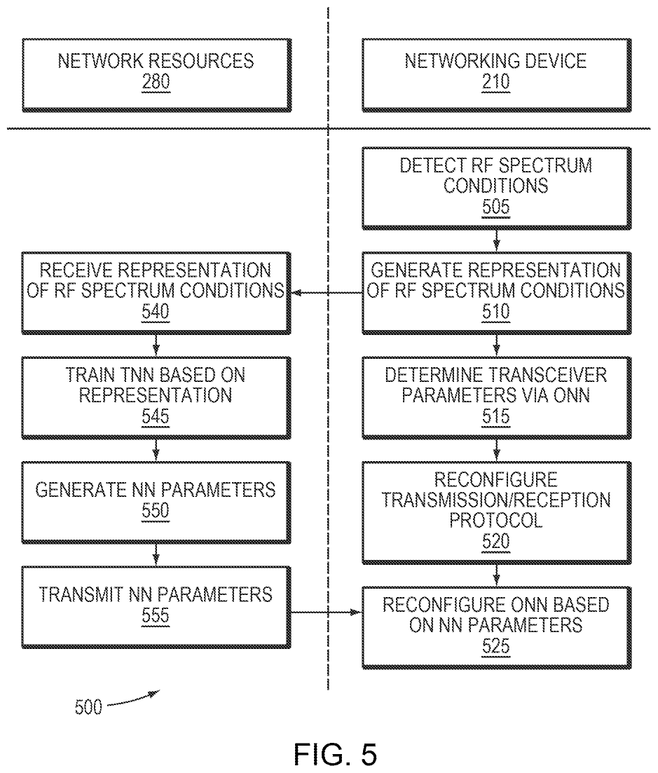

FIG. 5 is a flow diagram of a process 500 of configuring a wireless transceiver, which may be carried out in example embodiments. With reference to FIG. 2, at the networking device 210, the transceiver 214 may detect radio frequency (RF) spectrum conditions local to the networking device 210 (505) and generate a representation of the RF spectrum conditions (e.g., I/Q samples) (510). The ONN 212 may determine transceiver parameters (e.g., a DRL action result) based on the representation of the RF spectrum conditions (515). The controller 220 may then utilize the transceiver parameters to reconfigure at least one internal transmission or reception protocol of the transceiver 214 (520).

The controller 220 may also cause the representation of the RF spectrum conditions to be transmitted to a remote network node, where it is received by the network resources 280 (540). The TNN 285 may be trained based on the representation of the RF spectrum conditions (545), and the TNN 285 may generate NN parameters as a result of the training (550). The network resources 280 may then transmit the NN parameters to the networking device 510 (555). Using the NN parameters, the controller 220 may then reconfigure the ONN 212 to incorporate the NN parameters (525). Because the TNN 285 was trained with the representation of the RF spectrum conditions, the NN parameters may be a function of the representation of the RF spectrum conditions.

### Evaluation of Real-World Example Embodiment

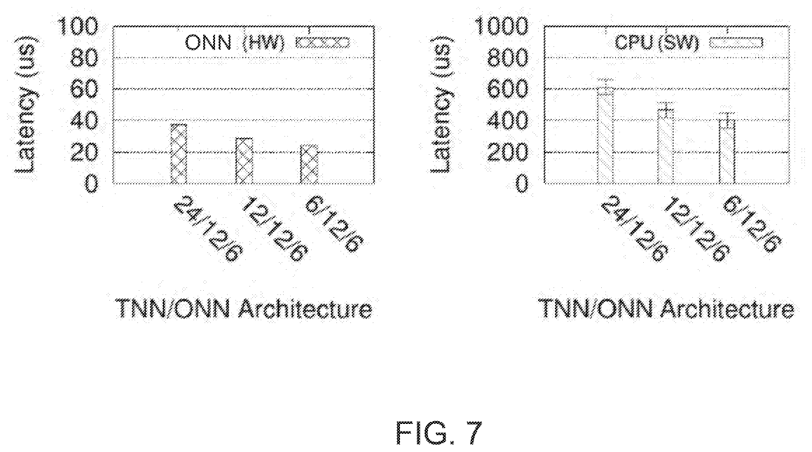

Referring again to FIG. 2, an example embodiment of the system 200 may be implemented as follows. The transceiver 214 of the networking device 210 may include a transmitter implementing a software-defined radio (SDR) platform, for example: (i) a Xilinx ZC706 evaluation board, which contains a Xilinx Zynq-7000 system-on-chip (SoC) equipped with two ACM Cortex CPU and a Kintex-7 FPGA; and (ii) an Analog Device FMCOMMS2 evaluation board equipped with a fully-reconfigurable AD9361 RF transceiver and VERT2450 antennas. The transceiver 210 may also include a receiver implemented on a Zedboard, which is also equipped with an AD9361 transceiver and a Zynq-7000 with a smaller FPGA. In both cases, the platform's software, drivers and data structures may be implemented in the C language, running on top of an embedded Linux kernel. The receiver's side of the OFDM configuration may be implemented on Gnuradio, while the controller 220 may be configured in C language for maximum performance and for easy FPGA access through drivers. Performance results of the example embodiment are described below with reference to FIGS. 7-12.

To maximize the state-action function, an improved cross entropy (CE) DRL method may be used, which is referred to as randomized CE with fixed episodes (RCEF). CE may be leveraged instead of more complex DRL algorithms because it possesses good convergence properties, and because it performs suitably in problems that do not require complex, multi-step policies and have short episodes with frequent rewards, as in the rate maximization problem. However, example embodiments provide a general framework that can support generalized DRL algorithms, including the more complex Deep Q-Learning.

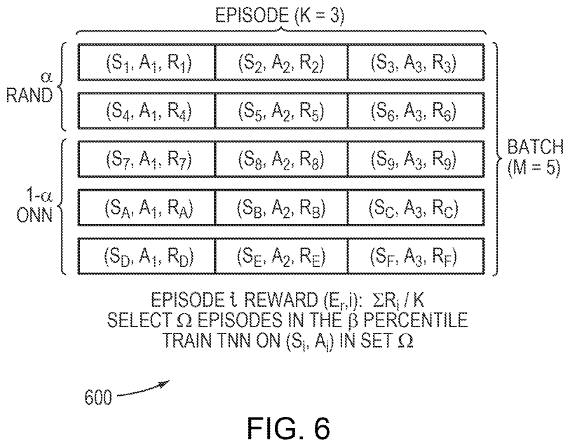

FIG. 6 is a table 600 illustrating RCEF in an example embodiment. RCEF may be implemented as a model-free, policy-based, on-policy method, meaning that (i) it does not build any model of the wireless transmission; (ii) directly approximates the policy of the wireless node; and (iii) uses fresh spectrum data obtained from the wireless channel. The CE method feeds experience to the wireless node through episodes, which is a sequence of spectrum observations obtained from the wireless environment, actions it has issued, and the corresponding rewards. Episodes are of fixed length K and are grouped in a batch of M episodes. At the beginning of each episode, the node can choose to either explore the action space with probability a or exploit the ONN knowledge with probability 1−a for the duration of the episode. After completion, episode i may be assigned a reward:

E_{r,i}=Σᵢ₌₀^{K}Rᵢ/K (6)

After the episodes in the batch are completed, RCEF may select the episodes belonging to the β percentile of rewards and puts them in a set Ω. The TNN is trained on the tuples (Sᵢ, Aᵢ) in Ω.

Because the policy under RCEF may be considered a probability distribution over the possible actions, the action decision problem boils down to a classification problem where the amount of classes equals the amount of actions. In other words, after the algorithm has converged, the transmitter only needs to (i) pass a spectrum observation to the ONN, (ii) get the probability distribution from the ONN output, and (iii) select the action to execute using that distribution. Such random sampling adds randomness to the agent, which is especially beneficial at the beginning of the process to explore the state action space.

FIG. 7 illustrates the latency performance of a real-world implementation of an ONN in an example embodiment (left), configured as described above, in contrast to a software implementation of a comparable deep neural network in C++ running on a CPU (right). In this comparison, FIG. 7 shows results with fixed N=12 and W=6 as D is the parameter that most impacts latency. The results were obtained with the circuit (e.g., FPGA) implementing the ONN set to a clock frequency to 100 MHz, while the RF front-end and the CPU are clocked at 200 MHz and 667 MHz, respectively. The latency results of the software implementation, shown at left, were obtained over 100 runs and with 90% confidence intervals. When compared to performance of the ONN at right, the results show that the latency of the ONN is about 16× times lower than the software implementation in PyTorch. According to Equation (3), in can be concluded that an achievable application rate in an example embodiment is 16× greater than in a comparable software implementation.

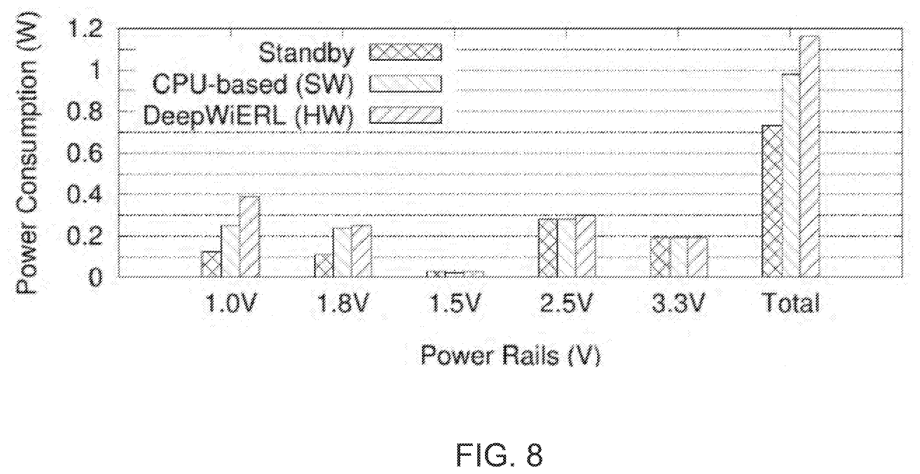

FIG. 8 illustrates the power consumption of the real-world implementation of an ONN as described above, in contrast to a software implementation of a comparable deep neural network. The results illustrate that a hardware-implemented ONN may consume more power (1.16 W vs 0.98 W), due to the involvement of the FPGA. However, as shown in FIG. 7, the ONN has an order of magnitude less latency than CPU. Therefore, the difference in energy consumption (597.8 μJ vs 42.92 μJ in the case of 24/12/6 model) makes the ONN in an example embodiment 14× more energy efficient than the CPU-based implementation.

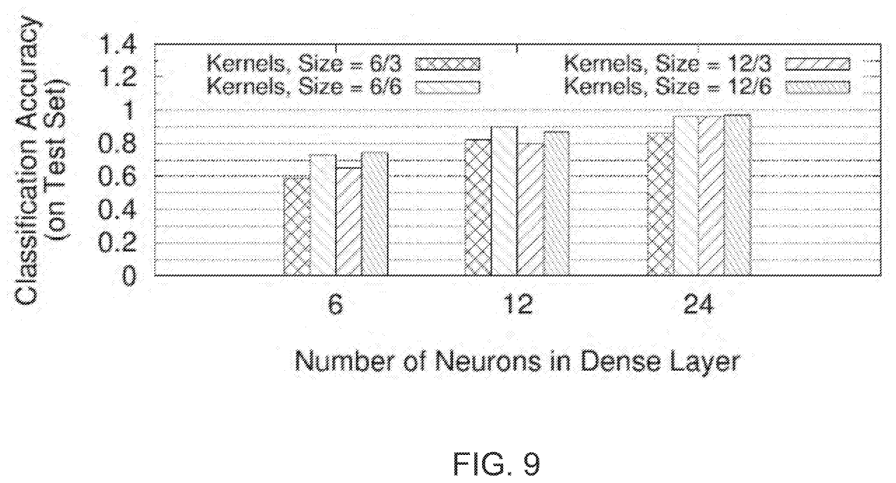

FIGS. 9-12 illustrate performance of the real-world implementation of an ONN as described above. For this analysis, 2.437 G as center frequency, which is the 6th WiFi channel, with a sampling rate of 10 MS/s.

FIG. 9 illustrates accuracy of DNN models as a function of the dense layer size, for different values of N (number of kernels) and W (kernel size). As shown, the dense layer size is the predominant hyper-parameter as it significantly impacts the classification accuracy of the DNN models. Furthermore, the number and size of kernels can impact the classification accuracy but to a lesser extent. Because the 24/12/6 model achieves the best performance, it may be selected as a reference DNN model.

FIG. 10 illustrates example training data comprising channel I/Q taps in a “Close” (e.g., 5 ft from a transmitter), “Medium” (e.g., 15 ft from a transmitter) and “Far” (e.g., 40 ft from a transmitter) scenarios. The S-DMSB process, as described above, determines the optimal DNN model to approximate the spectrum and thus select the appropriate action. To evaluate the convergence performance of RCEF in a real-world scenario, the Close and Far configurations may be considered, and the system is run with the 24/12/6 DNN model starting from a “clean-slate” (i.e., random parameter set).

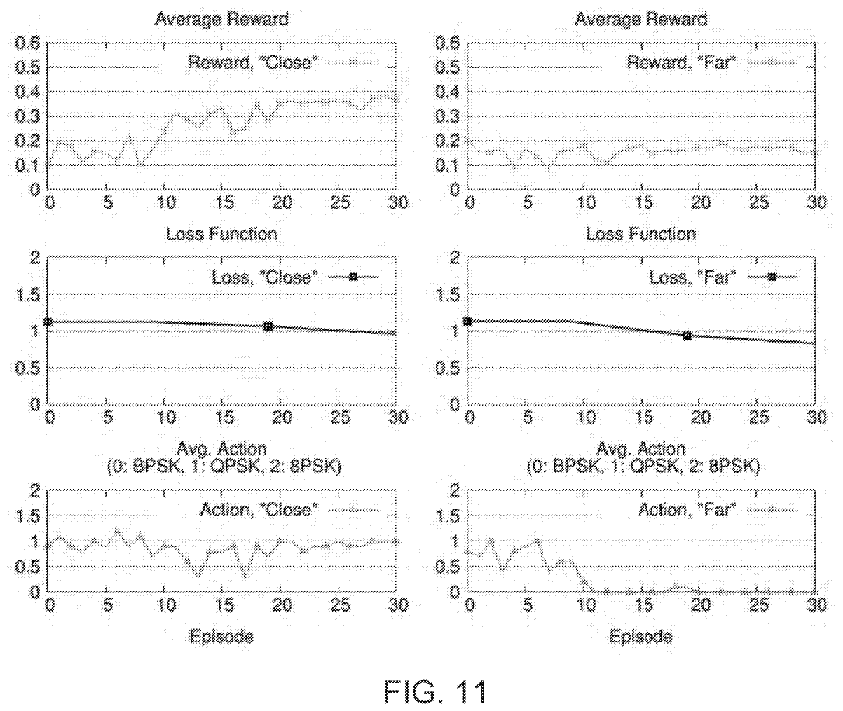

FIG. 11 illustrates the reward, loss function and average action per episode obtained by RCEF, as a function of the number of episodes. The average action is plotted as a real number between 0 and 2, where 0, 1 and 2 are assigned to BPSK, QPSK and 8PSK actions, respectively. For RCEF, K is fixed to 10, the batch size B to 10, and α and β to 0.1 and 0.7, respectively.

An expected behavior of the RCEF may be to converge to BPSK and 8PSK modulations in the Far and Close scenarios, respectively. However, FIG. 11 shows that in the Close scenario, the preferred action is to switch to QPSK instead of 8PSK. Indeed, this is due to the fact that in our testbed experiments the QPSK modulation performs better than the other two modulations, and RCEF is able to learn that without human intervention and based just on unprocessed spectrum data. FIG. 11 also indicates that RCEF converges faster in Far than in Close. This is because in the Far scenario the 8PSK transmissions always fail and thus the related observations are never recorded at the receiver's side. This, in turn, speeds up convergence significantly (i.e., 1 batch vs 2 batches in the Close scenario) as also indicated by the lower loss function values reported in FIG. 11.

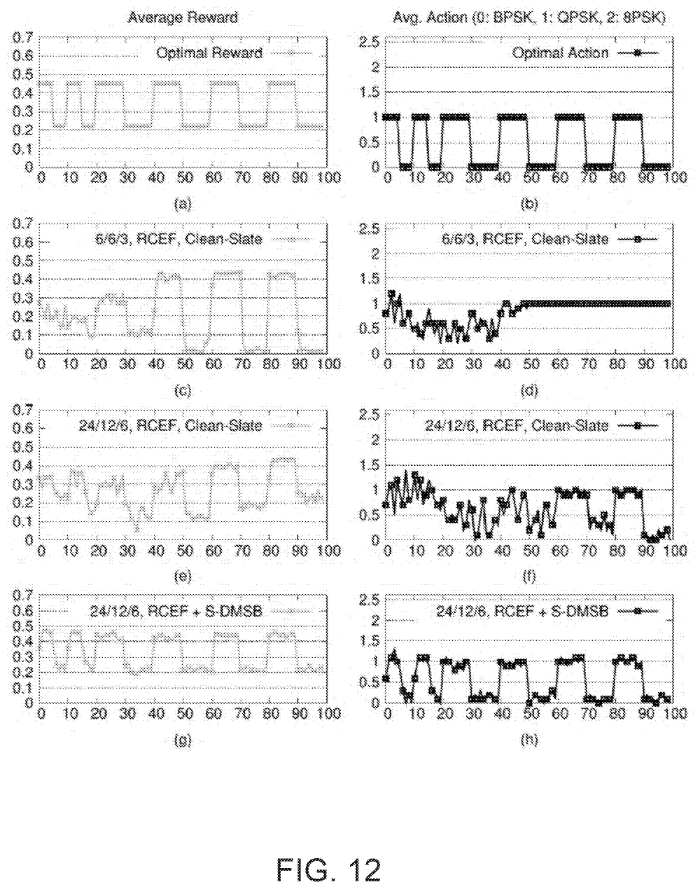

FIG. 12 illustrates average reward and action obtained by the RCEF and S-DMSB processes. The results shown were obtained in a controlled environment wherein the transmitter and receiver are connected through an RF cable and the SNR is changed instantaneously though the introduction of path loss. This was done to (i) explicitly control the RF channel impact and evaluate the convergence performance of RCEF and S-DMSB under repeatable conditions; (ii) determine the optimal reward and action at a given moment in time, which are shown respectively in (a) and (b). The SINK level is changed approximately one every 10 episodes, except for the first 20 episodes where it was changed every 5 episodes to improve convergence by the RCEF process. This was done to emulate highly-dynamic channel conditions between the transmitter and the receiver yet also evaluate the action chosen by the ONN as a function of the SNR.

FIG. 12 presents the average reward and action as a function of the episode number obtained by (i) RCEF with a “clean-slate” 6/6/3 DNN in (c) and (d), (i) RCEF with a “clean-slate” 24/12/6 DNN in (e) and (f), and RCEF with a “bootstrapped” 24/12/6 DNN in (g) and (h), obtained through the S-DMSB method described above with reference to FIG. 4, and with the data collected as described above with reference to FIG. 10. FIGS. 12(c) and (d) suggest that the 6/6/3 architecture is not able to capture the difference between different spectrum states, as it converges to a fixed QPSK modulation scheme regardless of the SNR levels experienced on the channel. On the other hand, (e) and (f) show that the 24/12/6 architecture performs much better in terms of convergence, as it is both able to distinguish between different spectrum states and is able to switch between BPSK and QPSK when the SNR level changes. However, as shown, that convergence does not happen until episode 60. Finally, (g) and (h) indicate that S-DMSB's bootstrapping procedure is significantly effective in the scenario considered. Indeed, an increase in average reward of more than 45% with respect to clean-slate RCEF is obtained, and a 6× speed-up in terms of convergence; RCEF+S-DMSB converges to the “seesaw” pattern at episode 10, while clean-slate RCEF converges at episode 60.

While example embodiments have been particularly shown and described, it will be understood by those skilled in the art that various changes in form and details may be made therein without departing from the scope of the embodiments encompassed by the appended claims.

What is claimed is:

1. A networking device, comprising:
a wireless transceiver configured to detect radio frequency (RF) spectrum conditions local to the networking device and generate a representation of the RF spectrum conditions;
a hardware-implemented operative neural network (ONN) configured to determine transceiver parameters based on the representation of the RF spectrum conditions; and
a controller configured to:
cause the representation of the RF spectrum conditions to be transmitted to a network node; and
reconfigure the ONN based on neural network (NN) parameters generated by a training neural network (TNN) remote from the networked device, the NN parameters being a function of the representation of the RF spectrum conditions.

2. The device of claim 1, wherein the representation of the RF spectrum conditions includes I/Q samples.

3. The device of claim 1, wherein the controller is further configured to generate an ONN input state based on the representation of the RF spectrum conditions, and wherein the ONN is further configured to process the ONN input state to determine the transceiver parameters.

4. The device of claim 1, wherein the wireless transceiver is further configured to reconfigure at least one internal transmission or reception protocol based on the transceiver parameters.

5. The device of claim 1, wherein, following the reconfiguration of the ONN based on the NN parameters, the ONN is further configured to determine subsequent transceiver parameters based on a subsequent representation of the RF spectrum conditions generated by the wireless transceiver.

6. The device of claim 1, wherein the networking device is a battery-powered Internet of things (IoT) device.

7. The device of claim 1, wherein the ONN is further configured to determine the transceiver parameters within 1 millisecond of the wireless transceiver generating a representation of the RF spectrum conditions.

8. The device of claim 1, wherein the ONN is configured in a first processing pipeline, and further comprising a second processing pipeline configured to 1) buffer the representation of the RF spectrum conditions concurrently with the ONN determining the transceiver parameters, and 2) provide the representation of the RF spectrum conditions to the wireless transceiver in synchronization with the transceiver parameters.

9. A method of configuring a wireless transceiver, comprising:
detecting radio frequency (RF) spectrum conditions local to the networking device and generating a representation of the RF spectrum conditions;
determining, at a hardware-implemented operative neural network (ONN), transceiver parameters based on the representation of the RF spectrum conditions;
reconfiguring at least one internal transmission or reception protocol of the wireless transceiver based on the transceiver parameters;
transmitting the representation of the RF spectrum conditions to a network node remote from the wireless transceiver; and
reconfiguring the ONN based on neural network (NN) parameters generated by a training neural network (TNN), the NN parameters being a function of the representation of the RF spectrum conditions.

10. The method of claim 9, further comprising:
training the TNN based on the representation of the RF spectrum conditions; and
generating, via the TNN, the NN parameters as a result of the training.

11. The method of claim 9, further comprising training the TNN in a manner that is asynchronous to operation of the ONN.

12. The method of claim 9, further comprising training the TNN based on at least one state/action/reward tuple generated from the representation of the RF spectrum.

13. The method of claim 12, further comprising updating a TNN experience buffer to include the at least one state/action/reward tuple.

14. The method of claim 9, further comprising transmitting the NN parameters from the network node to the wireless transceiver.

15. The method of claim 9, further comprising:
training a software-defined NN to classify among different state conditions of a RF spectrum;
translating the state of the software-defined NN to ONN parameters;
comparing the ONN parameters against at least one of a size constraint and a latency constraint; and
causing the ONN to be configured based on the ONN parameters.

16. A connected things device, comprising:
a connected things application configured to process an input stream of input data representing real-world sensed information and to produce an output stream of output stream data that is stored in a buffer and released from the buffer with the timing that is a function of real-world timing;
an operative neural network (ONN) configured to process the input stream of input data and produce a deep reinforcement learning (DRL) action at a rate aligned with the output of the buffer; and
an adapter configured to accept the output stream of data from the buffer and the DRL action and to produce an output that is a function of the DRL action.

17. The connected things device of claim 16 wherein the ONN has a processing latency that matches the latency of the connected things application and buffering such that the output stream of data and the DRL action are aligned with each other.

18. The connecting things device of claim 16 wherein the connected things application is coupled to real-world sensors that are configured to collect data at a rate sufficient to enable the I/O the connected things device to operate in real-time.

19. The connected things device of claim 16 wherein the ONN is implemented in a programmable logic device and is trained to reach a convergence based on continuous operation in a parallel flow path with the iota with the connected things application.

20. The connected things device of claim 16 wherein the ONN is configured to receive a DRL state input and TN and parameters input and configured to output a DRL action that is combined with the connected things application in a manner that real-world timing aligns corresponding states to be combined in a meaningful manner that enables the connected things device to perform actions in real-time.

21. The connected things device of claim 16 wherein the ONN is produced through a supervised training system that selects a neural network model as a function of latency and hardware size constraints.

22. The connected things device of claim 16 wherein the ONN is implemented in a programmable logic device and the connected things application is implemented in a processing system.

23. The connected things device of claim 16 wherein the connecting things application is coupled to the connected things device via a wireless communications path.
